(19) United States
(12) Patent Application Publication
(10) Pub. No.: US 2011/0017852 A1
(43) Pub. Date: Jan. 27, 2011

(54) STAGED CASCADE MILL

(75) Inventor: Wendell E. Howard, Austin, TX (US)

Correspondence Address: HUFFMAN LAW GROUP, P.C., 1900 MESA AVE., COLORADO SPRINGS, CO, 80906, US

(73) Assignee: DYNACORP ENGINEERING INC., Austin, TX (US)

(21) Appl. No.: 12/897,181

(22) Filed: Oct. 4, 2010

Related U.S. Application Data
(63) Continuation of application No. 12/050,434, filed on Mar. 18, 2008, now abandoned.
(60) Provisional application No. 60/896,650, filed on Mar. 23, 2007.

(51) Int. Cl. B02C 19/00

(52) U.S. Cl. 241/29; 241/154

(57) ABSTRACT

Material reduction apparatus is provided in the form of a staged cascade mill comprising a vertically stacked series of material reduction chambers, each having therein a single motor-driven rotor structure, the chambers being interconnected in a manner such that the material to be reduced in size may be sequentially passed through the chambers from the uppermost chamber to the lowermost chamber. Each of the stacked chambers has an adjustable reduction structure disposed therein and operative in a manner such that the material reduction action from the uppermost chamber to the lowermost chamber progressively changes from a predominantly impact type material reduction action to a predominantly crushing/grinding type material reduction action.

### CROSS-REFERENCE TO RELATED APPLICATION

This application claims the benefit of the filing date of U.S. Provisional Application Ser. No. 60/896,650 filed on May 23, 2007 and entitled “STAGED CASCADE MILL”, such provisional application being hereby incorporated herein by reference in its entirety.

### BACKGROUND OF THE INVENTION

The present invention generally relates to solids reduction and, in a representatively illustrated embodiment thereof, more particularly relates to a specially designed staged cascade mill for reducing solid materials.

Solids reduction is the process by which certain materials are ground, crushed or pulverized from a certain input size to a prescribed, smaller output size. Solids reduction technology is utilized in a wide array of commercial applications such as, for example, cement production, mining, utility and chemical processes, oil and gas processing, paper production and various agricultural applications.

Various devices have been developed and utilized to reduce the size of solids in these and other applications. One such device is called a ball mill. A ball mill typically includes a cylindrical or conical shell that rotates about a horizontal axis and, in a commonly utilized embodiment thereof, is partially filled with a large number of steel balls. The material to be reduced in size is suitably introduced into the shell, and the shell is rotationally driven by one or more motors in a manner such that the steel balls are caused to “cascade” within the shell—i.e., be lifted up and then caused to fall onto the material to be reduced. The impact of the falling balls against the material crushes the material and reduces it size. Additionally the movement of the balls along a bottom portion of the shell grinds and crushes the material disposed within the void spaces between these balls.

While ball mills have been successfully used in a number of industries, they have certain well known limitations and disadvantages. For example, the need to continuously lift a multiplicity of heavy steel balls to reduce the material typically requires a huge power input—often thousands of horsepower in large scale ball mills. Accordingly, the electrical cost required to operate a ball mill per ton of processed material can easily be cost prohibitive. Additionally, it is often difficult to accurately control the size of the reduced material exiting the typical ball mill.

From the foregoing it can readily be seen that a need exists for material reduction apparatus that eliminates or at least substantially reduces the above-mentioned limitations and disadvantages of a conventional ball mill as generally described above. It is to this need that the present invention is primarily directed.

### SUMMARY OF THE INVENTION

In carrying out principles of the present invention, in accordance with representatively illustrated embodiments thereof, material reduction apparatus is provided in the form of a staged cascade mill comprising a plurality of material reduction chambers interconnected in series in a manner such that material to be reduced from an initial size to a predetermined final size may be sequentially passed through the reduction chambers from a first one thereof to a last one thereof. The reduction chambers may each be disposed within its own separate housing structure, or a plurality of reduction chambers may be disposed in a single housing structure.

Illustratively, the reduction chambers each have a single motor-driven rotor structure therein, and are preferably arranged in a vertically stacked array with the uppermost reduction chamber being the first reduction chamber, and the lowermost reduction chamber being the last reduction chamber. Each of the reduction chambers has internal reduction structure for providing a portion of the overall required material size reduction by a combination of impact and crushing/grinding action. The percentage relationship between these two actions progressively changes in the reduction chambers from a predominantly impact action in the first reduction chamber to a predominantly crushing/grinding action in the last reduction chamber.

A recirculation system may be provided for returning material discharged from one of the reduction chambers to a preceding chamber for further processing. In an exemplary embodiment thereof the recirculation system comprises a separator for receiving the material discharged from one of the reduction chambers and separately discharging (1) sufficiently size-reduced material as a finished product, and (2) insufficiently size-reduced material for return to a preceding reduction chamber.

In each of the reduction chambers the aforementioned reduction structure illustratively includes a plurality of circumferentially spaced apart projections extending radially outwardly from the periphery of the chamber's rotor structure which is rotationally driven, preferably by a reversible motor. In downwardly successive ones of the reduction chambers the pluralities of projections extend around increasing circumferential portions of their associated rotor structures. At least some of such projections are provided with convexly curved radially outer side surfaces.

In each of the reduction chambers the reduction structure illustratively further includes a breaker member having a side surface facing the periphery of the chamber's rotor. The breaker member may be one of an opposed pair of breaker members horizontally facing diametrically opposite peripheral side surface portions of the rotor, and the breaker member is preferably supported for selective adjusting movement toward and away from the periphery of its associated rotor. For each reduction chamber its breaker members are illustratively carried on threaded rods threadingly extending through a housing wall portion associated with the particular chamber.

An inner side surface of at least one of the breaker members has an arcuate, generally toothed configuration, with the teeth on such side surface of at least one of the breaker members illustratively having flattened point portions. Further, at least one of the breaker members may have a substantially smooth arcuate inner side surface.

The overall material reduction apparatus may also include a non-single rotor material reduction apparatus such as, for example, a dual rotor hammer mill, operative to discharge partially size-reduced material into the uppermost reduction chamber of the staged cascade mill. The overall material reduction apparatus may also include a non-single rotor material reduction apparatus such as, for example, a pinch roller apparatus, operative to receive and further process size-reduced material discharged from the lowermost reduction chamber.

### BRIEF DESCRIPTION OF THE DRAWINGS

FIG. 1 is a schematic diagram of a representative staged material reduction cascade mill embodying principles of the present invention;

FIG. 2 is a graph showing a representative progressive transition from primarily impact reduction to primarily crushing/grinding reduction as material to be reduced in size vertically traverses the cascade mill in a downward direction;

FIGS. 3-5 are schematic depictions of various positional/configurational adjustment aspects of the individual stages (representatively five in number) of the cascade mill; and

FIGS. 6 and 7, respectively, schematically illustrate representative feed-in and discharge reduction structures positionable at the entrance and exit of the cascade mill.

### DETAILED DESCRIPTION

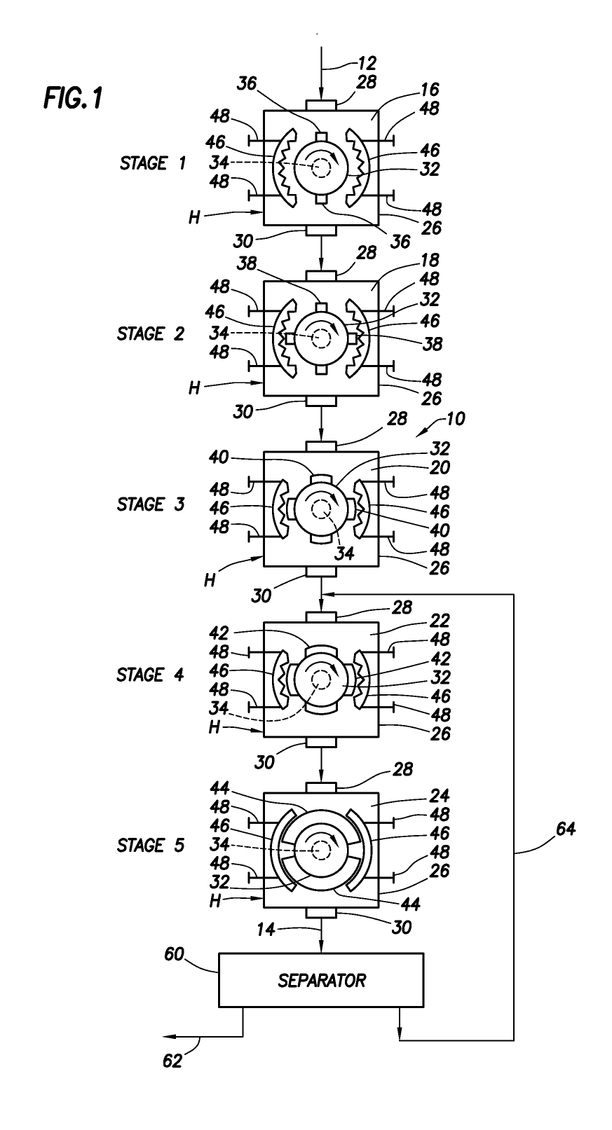

Schematically depicted in FIG. 1 is a representative embodiment of a solids reduction apparatus in the form of a staged cascade mill 10 embodying principles of the present invention and operative to progressively reduce a solid material, such as clinkers (kiln-dried limestone particles), from a certain input size fed into an upper end portion of the cascade mill 10 as at 12, to a prescribed, smaller output size discharged from a bottom end portion of the cascade mill 10 as at 14.

In the illustrated exemplary embodiment thereof the cascade mill 10 comprises a vertically stacked plurality of stages (representatively five in number) of material reduction carried out within the schematically illustrated five single rotor material reduction chambers generally identified, from top to bottom, by the reference numerals 16, 18, 20, 22 and 24 which respectively correspond to the aforementioned five stages of material reduction. Representatively, but not by way of limitation, each reduction chamber is disposed within its own separate housing H. However, if desired, a plurality of reduction chambers could be operatively disposed within a single housing structure without departing from principles of the present invention.

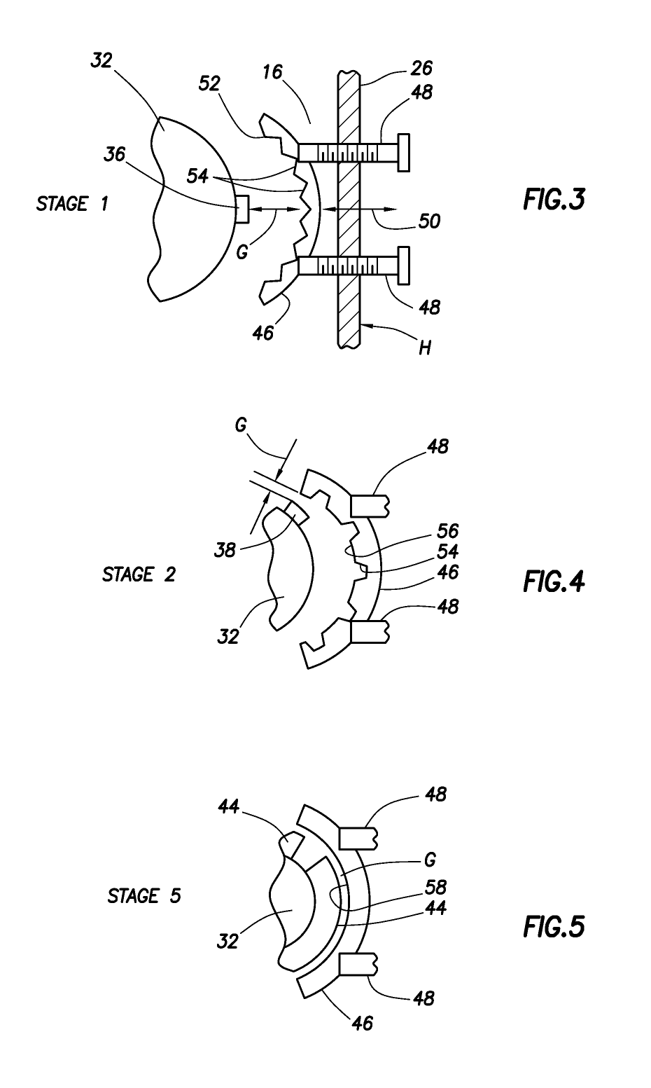

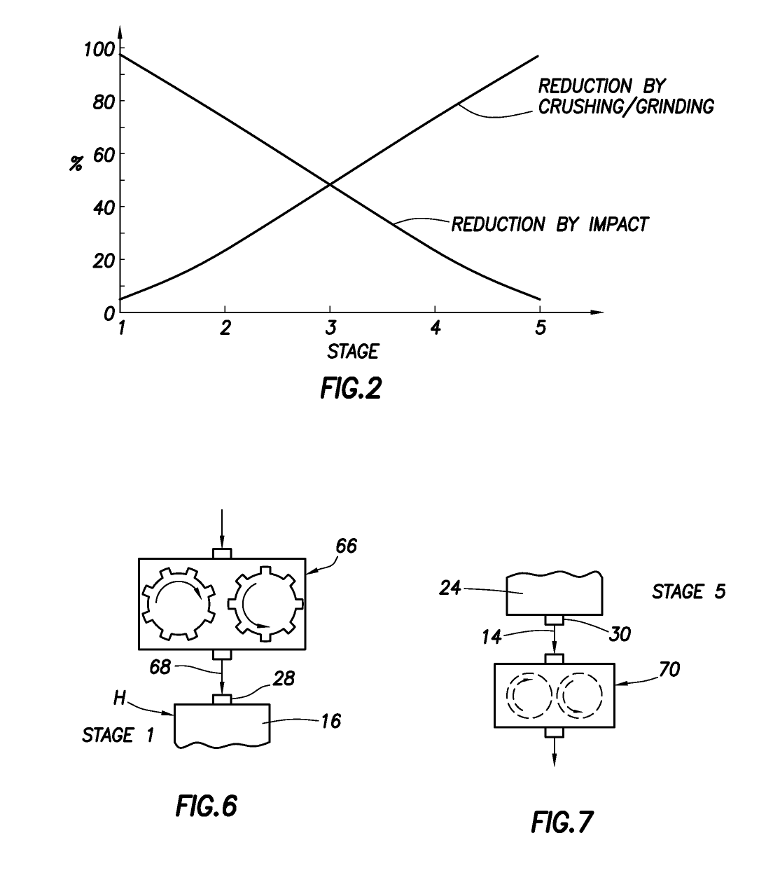

According to a key aspect of the present invention (as will subsequently be described in more detail herein) material reduction apparatus within the stage 1 (uppermost) reduction chamber 16 partially reduces the particle size of the incoming material predominantly by impact and to a far lesser extent by a crushing/grinding action. By way of non-limiting example, and with reference to the graph in FIG. 2, the material reduction apparatus within the uppermost reduction chamber 16 provides an initial stage of particle size reduction in which approximately 95% of the particle size reduction is achieved by impacting the particles, and approximately 5% of the particle size reduction is achieved by a crushing/grinding action on the particles within the reduction chamber 16.

As can be seen in the FIG. 2 graph, as the material exiting the uppermost reduction chamber 16 successively passes downwardly through the remaining second through fifth stage reduction chambers 18, 20, 22 and 24 the particle size of the material is subjected to further material reduction processes in which the impact reduction action on the material particles progressively decreases and the crushing/grinding reduction action on the material particles progressively increases until, within the stage 5 bottom reduction chamber 24 the impact reduction action created therein by its associated reduction apparatus has diminished to approximately 5% while the crushing/grinding action has increased to approximately 95%. Illustratively, the relationship between the crushing/grinding action increase and the impact action decrease in the exemplary cascade mill 10 is substantially linear such that in the middle (stage 3) reduction chamber 20 the impact and crushing/grinding actions therein are substantially equal. However, a variety of non-linear relationships between these two material reduction actions can be alternatively be utilized, if desired, without departing from principles of the present invention. Moreover, a greater or lesser number of material reduction stages may be used if desired; and the vertically successive stages may be horizontally offset from one another, without departing from principles of the present invention.

Compared, for example, to conventional ball mill type solids reduction processors, the cascade mill 10 provides substantial advantages. For example, the cascade mill 10 provides for significantly better control of discharged particle size. Additionally, for a given material throughput rate, a very sizeable reduction in operational energy is achieved. Further, as will be subsequently described herein, the cascade mill 10 may be easily “fine tuned” to accurately handle a variety of different materials to be reduced in size, or to accurately change the output particle size of the same material operatively traversing the mill 10.

As previously stated, representatively, but not by way of limitation, each of the material reduction chambers 16,18,20,22,24 is disposed within its own separate outer housing H which has a central material inlet opening 28 on its top wall, and a central material outlet opening 30 on its bottom wall. The five representative reduction chambers are illustrated as being horizontally aligned with one another in a manner such that the outlet opening 30 of each reduction chamber is aligned with the inlet opening 32 of the downwardly adjacent reduction chamber in the series thereof. Alternatively, however, the reduction chambers could be horizontally staggered with respect to one another if desired, with suitable passages being formed between adjacent reduction chamber inlet and outlet openings.

A single rotor structure 32 is disposed within each of the reduction chambers 16,18,20,22 and 24 and is rotationally drivable therein, representatively in a clockwise direction as viewed in FIG. 1, by a suitable motor 34. Preferably, each motor 34 is reversible so that wear on subsequently described particle reduction structure within the interior of each reduction chamber may be equalized over time.

Extending radially outwardly from the periphery of each rotor 32 are a plurality of material reduction projections. Representatively, but not by way of limitation, these projections include:

(1) a diametrically opposed pair of radially outwardly extending projections 36 disposed on the periphery of the rotor portion 32 of the stage 1 reduction chamber 16;

(2) four projections 38 equally spaced around the periphery of the rotor portion 32 of the stage 2 reduction chamber 18, the projections 38 being substantially identical to the projections 36;

(3) four projections 40 equally spaced around the periphery of the rotor portion 32 of the stage 3 reduction chamber 20, each of the projections 40 being circumferentially wider than the projections 38;

(4) four projections 42 equally spaced around the periphery of the rotor portion 32 of the stage 4 reduction chamber 22, each of the projections 40 being circumferentially wider than the projections 40; and

(5) two diametrically opposite projections 44 disposed on the periphery of the rotor portion 32 of the stage 5 reduction chamber 24, the projections 44 being circumferentially spaced apart, but combinatively extending around nearly the entire periphery of the rotor portion 32 of the stage 5 reduction chamber 24.

As can be seen, in each downwardly successive reduction chamber, the projections on its rotor portion 32 occupy a greater circumferential portion of the rotor periphery. Accordingly, each downwardly successive rotor portion 32 is provided with a greater degree of grinding/crushing type material reduction capability than its upwardly preceding rotor portion, while each upwardly successive rotor portion 32 is provided with a greater degree of impact type material reduction capability then its downwardly preceding rotor portion. As can further be seen, the rotor projections 40,42 and 44 are representatively provided with curved radially outer side surfaces to enhance the grinding/crushing portions of their material reduction actions.

With reference now to FIGS. 1 and 3-5, each of the five rotor portions 32 is illustratively disposed between two horizontally facing, representatively arcuate breaker plate structures 46 which form a portion of the overall reduction structure within their associated reduction chamber. The breaker plate structures 46 in each opposed pair thereof are mounted on opposite vertical side walls 26 of their associated housing H (see, e.g., FIG. 3) by a pair of threaded adjustment rods 48 which project outwardly from the housing side walls 26, are threadingly connected thereto, and are rotatably connected at their inner ends to their associated breaker plate structures 46. As shown in FIG. 3, rotation of the rods 48 in the appropriate direction causes their breaker plate structure 46 to move toward or away from its associated rotor projections (such as the illustrated stage 1 projections 36) to thereby selectively vary the gap G between the inner side of the breaker plate structure and the rotor projections as indicated by the double-ended arrow 50 in FIG. 3. This positional adjustment of the breaker plate structures 46 may be carried out during operation of the cascade mill 10, and may be used to compensate for internal structure wear in its various stages and/or selectively vary the material reduction characteristics in any or all of such stages.

Illustratively, the inner side surfaces of the breaker plate structures 46 in the first through fourth stage reduction chambers 16,18,20 and 22 have generally toothed configurations. In the stage 1 reduction chamber 16 (see FIG. 3) the teeth have points 52 flanked by flat side surfaces 54. During motor-driven rotation of the rotor structure 32 in the stage 1 reduction chamber 16, its rotating projections 36 throw solid material particles against these flat side surfaces 54 to reduce their size essentially entirely by an impact process, the gap G being set fairly wide to facilitate this impact reduction. Only a small degree of crushing/grinding type material size reduction is effected in the stage 1 reduction chamber 16, such crushing/grinding action being carried out primarily on relatively large particles which are crushed or ground between the projections and the inner side surface of the right breaker plate structure 46.

Referring now to FIG. 4, in the stage 2 reduction chamber 18, the gap G is somewhat narrowed, and the breaker plate structure tooth points are provided with a somewhat flattened configuration, as at 56, which correspondingly reduces the impact surface area of the tooth side surfaces 54. Thus, the flattened tooth point surface areas 56, coupled with the increased circumferential area of the projections 38, provide an increased material crushing/grinding area within the stage 2 reduction chamber 18, while the reduction in impact area on the breaker plate structure reduces the material impact type reduction capability within the reduction chamber 18. Accordingly, relative to the stage 1 reduction chamber 16, the stage 2 reduction 18 has therein an increased crushing/grinding material reduction action, and a decreased impact type material reduction capability.

In the stage 3 and stage 4 reduction chambers 20 and 22 this crushing/grinding increase and impact decrease theme is progressively continued. Specifically, in the stage 3 reduction chamber 20 the tooth points 52 are further flattened, and the gap G is further decreased, relative to their counterparts in the stage 2 reduction chamber 18. In the stage 4 reduction chamber 22 the tooth points are further flattened, and the gap G is further decreased, relative to their counterparts in the stage 3 reduction chamber 20.

In the stage 5 reduction chamber 24 (see FIG. 5) the inner side surface 58 of each of the breaker plate structures 46 is representatively provided with an essentially smooth arcuate configuration having a curvature matching the outer side surface curvatures of the rotor projections 44, and the gap G is further narrowed. Accordingly, in the stage 5 reduction chamber 24 the material reduction action is substantially entirely carried out by crushing/grinding of the material between the projections 44 and the inner side surface 58 of the illustrated breaker plate structure 46.

As can be seen from the foregoing, the relative configurations of the rotor projections and the breaker plate structures in the vertically stacked material reduction chambers 16,18,20,22 and 24 coupled with the adjustment capabilities of the breaker plate structures provide the cascade mill 10 with the unique capability of reducing the size of received material particles using a progressive chamber-to-chamber shift from a predominantly impact reduction action to a predominantly crushing/grinding reduction action.

The actual shapes of internal chamber material reduction components and adjustment techniques previously described herein are merely representative, and can be modified in a wide variety of manners without departing from principles of the present invention. Further, there may be a greater or fewer number of material reduction chambers utilized, as dictated by the particular material reduction task at hand. Also, while it is preferable to arrange the plurality of material reduction chambers in a vertically stacked array (to take advantage of gravity feeding of partially reduced material to the next reduction chamber), the plurality of material reduction chambers could alternatively be arranged in a horizontally disposed array with suitable transport apparatus being utilized to lift the partially reduced material discharged from a given reduction chamber to the inlet of the next successive reduction chamber in the reduction chain. Also, as previously mentioned, two or more reduction chambers could be positioned within a single housing H, if desired, without departing from principles of the present invention.

Another modification which could be made to the stages cascade mill 10 described above is, as schematically shown in FIG. 1, to provide it with a recirculation section to route size-reduced material discharged from the mill back to at least one of the stages thereof for further processing. Such recirculation section could include a suitable separator 60 operative receive the material discharge flow 14 from final reduction chamber 24 of the cascade mill 10, discharge (as at 62) the satisfactorily reduced material as finished product, and recirculate (as at 64) still-too-large material particles to the inlet opening 28 of one of the previous reduction chambers of the cascade mill 10, for example the reduction chamber 22, via suitable conventional conveyor/elevator apparatus well known in the material handling art.

The uniquely configured and operative stacked material reduction chambers 16,18,20,22 and 24 shown in FIG. 1 may be used by themselves, or combined in a number of manners with conventional solid material reduction apparatus. For example, as shown in FIG. 6, a conventional dual rotor hammer mill type material reduction apparatus 66 may be connected to the inlet side of the stage 1 cascade mill reduction chamber 16, with the partially reduced material discharge flow 68 exiting the hammer mill 68 being delivered to the inlet 28 of the stage 1 cascade mill reduction chamber 16. As another example, as shown in FIG. 7, a conventional twin pinch roller material reduction apparatus 70 may be operatively coupled to the discharge side of the fifth stage cascade mill reduction chamber 24 to receive and further process the reduced material flow 14 being discharged therefrom.

The foregoing detailed description is to be clearly understood as being given by way of illustration and example only, the spirit and scope of the present invention being limited solely by the appended claims.

1. Material reduction apparatus comprising:
a plurality of material reduction chambers interconnected in series in a manner such that material to be reduced from an initial size to a predetermined final size may be sequentially passed through said plurality of material reduction chambers from a first one thereof to a last one thereof,
each of said material reduction chambers having internal reduction structure for providing a portion of the overall required material size reduction by a combination of impact and crushing/grinding actions,
the percentage relationship between said actions progressively changing in said material reduction chambers from a predominantly impact action in said first material reduction chamber to a predominantly crushing/grinding action in said last material reduction chamber,
each of said internal reduction structures comprising a rotor portion disposed between two facing breaker plate portions selectively adjustable toward and away from said rotor portion, the configurations of the rotor and breaker portions in said material reduction chambers varying from chamber to chamber.

2. The material reduction apparatus of claim 1 wherein:
said material reduction chambers are in a vertically stacked array, with the uppermost material reduction chamber being said first material reduction chamber and the lowermost material reduction chamber being said last material reduction chamber.

3. The material reduction apparatus of claim 1 wherein:
each of said material reduction chambers contains a single motor-driven rotor structure.

4. The material reduction apparatus of claim 1 further comprising:
a recirculation system for returning material discharged from one of said material reduction chambers to a preceding material reduction chamber for further processing therein.

5. The material reduction apparatus of claim 4 wherein:
said recirculation system includes a separator for receiving the material discharged from said one of said material reduction chambers and separately discharging (1) sufficiently size-reduced material as a finished product, and (2) insufficiently size-reduced material for return to said preceding material reduction chamber.

6. Material reduction apparatus comprising:
a staged cascade mill having a vertically stacked plurality of material reduction chambers interconnected in series in a manner such that material to be reduced from an initial size to a predetermined final size may be sequentially passed through said material reduction chambers from the uppermost one to the lowermost one,
each of said material reduction chambers having, within its interior, a single, motor-driven rotor structure and associated reduction structure for providing a portion of the overall required material size reduction by a combination of impact and crushing/grinding actions,
the percentage relationship between said actions progressively changing in said material reduction chambers from a predominantly impact action in said uppermost material reduction chamber to a predominantly rushing/grinding action in said lowermost material reduction chamber.

7. The material reduction apparatus of claim 6 wherein:
in each of said material reduction chambers said reduction structure includes a plurality of circumferentially spaced apart projections extending radially outwardly from the periphery of said rotor structure.

8. The material reduction apparatus of claim 7 wherein:
in downwardly successive ones of said material reduction chambers said pluralities of projections extend around increasing circumferential portions of their associated rotor structures.

9. The material reduction apparatus of claim 8 wherein:
at least some of said projections have convexly curved radially outer side surfaces.

10. The material reduction apparatus of claim 7 wherein:
in each of said material reduction chambers said reduction structure further includes a breaker member having a side surface facing said periphery of said rotor.

11. The material reduction apparatus of claim 10 wherein:
each of said breaker members is supported for selective adjusting movement toward and away from the periphery of its associated rotor structure.

12. The material reduction apparatus of claim 11 wherein:
each material reduction chamber is disposed with an associated housing wall structure,
with said breaker member in the material reduction chamber being carried by threaded adjustment rods threadingly extending through said housing wall structure.

13. The material reduction apparatus of claim 10 wherein:
said side surface of at least one of said breaker members has an arcuate, generally toothed configuration.

14. The material reduction apparatus of claim 13 wherein:
the teeth on said side surface of at least one of said breaker members have flattened point portions.

15. The material reduction apparatus of claim 10 wherein:
said side surface of at least one of said breaker members has an arcuate, generally smooth configuration.

16. The material reduction apparatus of claim 6 further comprising:
a recirculation system for returning material discharged from one of said material reduction chambers to a preceding material reduction chamber for further processing therein.

17. The material reduction apparatus of claim 16 wherein:
said recirculation system includes a separator for receiving the material discharged from said one of said material reduction chambers and separately discharging (1) sufficiently size-reduced material as a finished product, and (2) insufficiently size-reduced material for return to said preceding material reduction chamber.

18. The material reduction apparatus of claim 6 further comprising:
a non-single rotor material reduction apparatus operative to discharge partially size-reduced material into said uppermost material reduction chamber.

19. The material reduction apparatus of claim 6 further comprising:
a non-single rotor material reduction apparatus operative to receive and further process size-reduced material discharged from said lowermost material reduction chamber.

20. A material size reduction method comprising the steps of:
forming a plurality of material reduction chambers;
interconnecting said material reduction chambers in a series relationship;
permitting a material to be size-reduced to internally traverse said material reduction chambers from a first one thereof to a last one thereof;
providing material reduction structure in each of said material reduction chambers; and
operating said material reduction structures in a manner causing them to sequentially provide the material with portions of a predetermined overall size reduction thereof by a combination of impact and crushing/grinding actions in a manner such that the percentage relationship between said actions progressively changes from a predominantly impact action in the first material reduction chamber to a predominantly crushing/grinding action in the last material reduction chamber.
